(19) United States
(12) Patent Application Publication
(10) Pub. No.: US 2014/0272640 A1
(43) Pub. Date: Sep. 18, 2014

(54) MULTIFUNCTIONAL ELECTROCHEMICAL DEVICES

(71) Applicant: MCALISTER TECHNOLOGIES, LLC, Phoenix, AZ (US)

(72) Inventor: Roy Edward McAlister, Phoenix, AZ (US)

(73) Assignee: MCALISTER TECHNOLOGIES, LLC, Phoenix, AZ (US)

(21) Appl. No.: 14/217,262

(22) Filed: Mar. 17, 2014

Related U.S. Application Data
(60) Provisional application No. 61/786,339, filed on Mar. 15, 2013.

(51) Int. Cl. H01M 8/18

(52) U.S. Cl. CPC H01M 8/186
USPC 429/418

(57) ABSTRACT

Methods, systems, and devices are disclosed for fabricating and implementing multifunctional fuel cells. In one aspect, a multifunctional fuel cell device includes a first electrode and a second electrode separated by a distance and aligned substantially in parallel, a first conduit and a second conduit coupled to the first electrode and the second electrode, respectively, substantially perpendicular to the electrodes, and a fluid including an electrolyte, the fluid dispersed between the electrodes, in which an applied electric potential across the first and second conduits induces oppositely charged sides of the first and second electrodes to form a cathode and an anode side of each electrode, thereby extracting energy from the electrolyte and producing a chemical product.

### CROSS-REFERENCE TO RELATED APPLICATION(S)

This patent document claims the benefit of priority of U.S. Provisional Patent Application No. 61/786,339, entitled “NANOSCALE REVERSIBLE FUEL CELL DEVICES” and filed on Mar. 15, 2013. The entire content of the aforementioned patent application is incorporated by reference as part of the disclosure of this patent document.

### TECHNICAL FIELD

This patent document relates to systems, devices, and processes that use nanoscale electrochemical device technologies.

### BACKGROUND

Nanotechnology provides techniques or processes for fabricating structures, devices, and systems with features at a molecular or atomic scale, e.g., structures in a range of about one to hundreds of nanometers in some applications. For example, nano-scale devices can be configured to sizes similar to some large molecules, e.g., biomolecules such as enzymes. Nano-sized materials used to create a nanostructure, nanodevice, or a nanosystem can exhibit various unique properties, e.g., including optical properties, that are not present in the same materials at larger dimensions and such unique properties can be exploited for a wide range of applications. In certain instances, for example, nano-scale devices are assembled and/or utilized in groups and populations that create micro or macro-scale systems.

Electrochemical devices can include various types of electrolyzer or fuel cell devices. For example, a fuel cell is a device that converts chemical energy from a substance (e.g., referred to as a fuel) into electrical energy (e.g., electricity). Generally, the energy conversion includes a chemical reaction with oxygen or another oxidizing agent, e.g., such as a halogen. For example, hydrogen is among many common fuels, and hydrocarbons such as natural gas and alcohols can also be used in fuel cells. For example, fuel cells differ from batteries in that they require a replenishing source of fuel and oxygen to provide continued operation, but can produce electricity continually provided the fuel and oxygen inputs are supplied to the fuel cell.

### SUMMARY

Disclosed are multifunctional electrochemical devices and methods for fabricating and implementing such multifunctional electrochemical devices including fuel cells and electrolyzers formed of nanoscale-engineered materials.

### BRIEF DESCRIPTION OF THE DRAWINGS

FIG. 1 shows a schematic diagram of an exemplary unit cell of a multifunctional fuel cell device of the disclosed technology.

FIG. 2 shows a schematic diagram of another exemplary unit cell of a multifunctional fuel cell device of the disclosed technology.

FIG. 3 shows a schematic diagram of another exemplary unit cell of a multifunctional fuel cell device of the disclosed technology.

FIG. 4 shows a schematic diagram of an exemplary integrated unit cell of a multifunctional fuel cell device of the disclosed technology.

FIG. 5 shows a schematic diagram of an exemplary multifunctional fuel cell device of the disclosed technology.

FIGS. 6A-6E show illustrative schematic diagrams of a method to produce a fuel using an exemplary multifunctional fuel cell device.

### DETAILED DESCRIPTION

Conventional fuel cell technologies generally include large devices that employ large area electrodes and ion exchange media and are costly assemblies of mechanical and chemical components. For example, some existing fuel cell devices can generate power from inorganic fuels, but many of these devices produce substantial carbon footprints when processed and refined. Also, due to the size and expense associated with existing fuel cell devices, there has not been a widespread commercial adoption since their introduction and the technology has been limited to particular applications, e.g., such as in the Space Shuttle program and automotive applications.

The disclosed technology includes devices, systems, and techniques for producing and implementing multifunctional fuel cells and electrolyzers formed of nanoscale-engineered materials.

The disclosed electrochemical devices can be operated to provide multiple functions, including functions of a fuel cell, where a ‘fuel’ substance is chemically converted to produce electrical energy, and an electrolyzer, where electrical energy is provided to drive a chemical reaction to form chemical products. The disclosed devices can be operated to concurrently provide the functions of a fuel cell and an electrolyzer, or to provide a selected function of each type device. Throughout this patent document, such multifunctional electrochemical device technologies may be referred to as ‘multifunctional fuel cell devices’, while including functionalities beyond that of fuel cell technology, e.g., such as including electrolyzer technology. The described multifunctional fuel cells and/or electrolyzer devices of the disclosed technology can be produced, fabricated, and manufactured using nanoscale materials and technologies to create nano-, micro-, and macro-size scale devices and systems. In addition to size, other design factors including composition, structure, layer orientation, dopants, etc., can be determined before and during the fabrication of nanomaterials and nanodevices, in order to engineer it with desired properties and functionalities. For example, materials and devices fabricated by the disclosed technology can be produced for use in a variety of industries including, but not limited to, clean energy, filter technology, fuel technology, production of chemicals, pharmaceuticals, nanomaterials, and biotechnology, building materials and construction, durable goods, among many others.

In one aspect, the disclosed fuel cell technology includes devices that can store energy and produce energy in a reversible manner. The disclosed multifunctional fuel cell devices can be configured to have specialized functions. In some implementations, for example, a multifunctional fuel cell device can receive energy, e.g., such as electrical energy converted from a waste stream or selected renewable sources like wind, moving water, or solar (e.g., photovoltaic energy), to produce new chemical products on or between the electrodes of the fuel cell device. In other implementations, for example, a multifunctional fuel cell device can produce electrical energy at the electrodes of the fuel cell device by converting chemical energy contained in an electrolyte between the electrodes. Whereas in some implementations, for example, a multifunctional fuel cell device can produce desired chemical products and extract energy during such chemical production for the electrodes and ion exchange media to produce electrical energy. For example, an exemplary fuel cell device can be used to produce water from an electrolyte used in the fuel cell device, illustrated in Equation 1, as electrical energy is extracted from the electrolyte or fuel by the device.

H₂+½O₂ [symbol] H₂O (Eq. 1)

The disclosed fuel cell devices include an exemplary unit cell formed of nanoscale-engineered materials that can facilitate the multifunctional (e.g., reversible) production of, for example, water, and keep the hydrogen and/or water in storage, process inventories, or captivity within the unit cell structure. Various examples of unit cells of the disclosed multifunctional fuel cell device are shown in FIGS. 1-4.

FIG. 1 shows a schematic diagram of a unit cell 100, e.g., which can be used in an exemplary embodiment of a multifunctional fuel cell device of the disclosed technology. The unit cell 100 includes an electrode pair including electrode 101 and electrode 102, in which each electrode is connected and electrically coupled to a conduit and separated from each other by a distance. The electrode 101 is coupled to a conduit 111, and the electrode 102 is coupled to a conduit 112. The separation distance and orientation (e.g., rotational alignment and translational offset) between the electrodes 101 and 102 can be provided for selected ion exchange media and may be controlled by exemplary methods to manufacture the unit cell.

In some embodiments, for example, the electrodes of the unit cell 100 can be configured as single or multiple wall nanotubes that are parallel or juxtapositioned in overlapping orientations and/or one or more layers of graphene, in which one side of a graphene sheet exhibits a charge of a particular polarity while the other side of the graphene sheet exhibits the opposite charge. The charge presented on the facing sides of the electrodes 101 and 102 of the unit cell 100 can be provided by an applied or generated voltage on the conduits 111 and 112, respectively.

The conduit 111 is configured in this exemplary embodiment situated at an intersecting orientation such as substantially perpendicular to the orientation of the one or more layers that form the electrode 101. Likewise, the conduit 112 is also configured as substantially perpendicular to the orientation of the one or more layers that form the electrode 102. In this exemplary embodiment, the orientations of the layers that form the electrodes 101 and 102 may be substantially parallel, which can provide a suitably strong uniform electric field between the layers when the charge is generated or applied to the unit cell 100.

In some implementations, for example, the electrodes and conduits of the unit cell 100 can be configured of crystalline materials that form the one or more layers of the electrode and conduit structures, e.g., including one or more layers of synthetic carbon-based crystalline matrices, boron nitride crystalline matrices, and/or mica-based crystalline matrices, among others. For example, the crystalline matrix of the electrode and/or conduit structures can be loaded with another substance, e.g., including interstitial or edge dopants of the crystalline matrix. The engineered system and design of the crystalline matrix of the electrode and/or conduit structures can be specialized (e.g., arranged of particular materials and in specific configurations) so that these structures exhibit particular functional properties, e.g., including electrical conductivity or resistivity, along with selected magnetic, optical, thermal, and acoustic conductive and/or radiative properties, chemical and catalytic properties, and mechanical and capillary and/or sorptive properties, among others. For example, the engineered design of the crystalline matrix of the electrode and/or conduit structures can be specialized by its material composition, layer orientation, geometry and shape, additional surface structures located on its layers (e.g., edge characteristics, dopants, and/or coatings (including catalysts)), among other material design characteristics, functions and factors. In some implementations, for example, the one or more layers of the crystalline matrix of the electrode and/or conduit structures can be configured to conduct electric charge (e.g., electrons) and heat along the crystalline plane of each of the layers, while being substantially insulative (e.g., electrically insulative and thermally insulative) across the crystalline plane.

The inset of FIG. 1 shows an exemplary interface between the electrode 101 and the conduit 111 of the unit cell 100. In this example, the conduit 111 includes a plurality of layers of a synthetic crystalline matrix structured to include (i) spacer components 107 between the layers at determined location(s) along the layers and/or (ii) interstitial and/or edge components 108 within or on the synthetic crystalline matrix of the layers. In some implementations, for example, the spacer components 107 can include individual atoms, molecules, or synthetic structures (e.g., carbon nanotubes, nanoscrolls, or other nanostructure); and the interstitial and/or edge components 108 can include individual atoms, molecules, or synthetic structures. In the exemplary embodiment shown in the inset of FIG. 1, the spacer components 107 provide an electrically conductive path for charge carriers to transfer from conduction along each layer of the conduit 111 to and from one or more layers of the electrode 101. Also, as illustratively depicted in the inset of FIG. 1, the interstitial and/or edge components 108 provide an electrically conductive path for charge carriers to transfer from conduction along each layer of the conduit 111 to and from one or more layers of the electrode 101.

The unit cell 100 can be implemented in a multifunctional electrochemical device, where an electrical potential can be applied across the electrodes 101 and 102 (e.g., by applying an electrical signal to the conduits 111 and 112) to affect an electrolyte (e.g., proton exchange membrane or polymer electrolyte membrane (PEM), perovskite material, electrolytic fluid, thin film, or other electrolytic material), which can be supplied between the electrodes 101 and 102 of the unit cell 100, to produce a chemical product and/or extract energy from the electrolyte (concurrently).

In some implementations of the multifunctional electrochemical devices of the disclosed technology, for example, an electrolyte separating the electrodes provides transmission of ions but prevents transmission of gases or electrons. Electrons must be delivered to or from electrodes by an external circuit which may include a device that performs work, generates heat, etc. However electrons or current may also be provided by the synergistic utilization of a piezoelectric, thermoelectric or photovoltaic functionalities of the structural and material designs of the disclosed electrochemical devices to provide current to drive electrolysis events in the electrochemical cell.

In some embodiments, the engineered materials that can be used to form the electrode and conduit structures of the exemplary unit cells of the disclosed multifunctional fuel cell technology can include architectural constructs as described in the U.S. Patent documents: U.S. Patent Publication US2011/0206915A1, entitled “ARCHITECTURAL CONSTRUCT HAVING FOR EXAMPLE A PLURALITY ARCHITECTURAL CRYSTALS”, and U.S. Patent Publication US2013/0101808A1, entitled “ARCHITECTURAL CONSTRUCT HAVING A PLURALITY OF IMPLEMENTATIONS”, both of which are incorporated by reference in their entirety as part of the disclosure in this patent document. For example, exemplary methods to manufacture the unit cell, including spacer components and/or interstitial or edge atoms or molecules of the architectural constructs to fabricate such engineered materials with tailored functional properties, are disclosed in these aforementioned U.S. Patent Publication US2011/0206915A1 US2013/0101808A1 referenced herein.

Functions and implementations of architectural constructs can be based on the design factors of the architectural construct. Such architectural construct design factors can include its composition, matrix characterization, dopants, edge atoms, surface coatings, and configuration of layers, e.g., their number, thickness, orientation, and geometry, the spacer components used in between along with the properties of such spacers, and amount of space between the layers. For example, by configuring the size, quantity, orientation, spacing distance of layers in an architectural construct using the disclosed fabrication methods, new engineered materials can be produced, fabricated, and manufactured on a nano-, micro-, and macro-size scale. In addition to size, other design factors including composition, crystal structure, layer orientation, dopants, etc., can be determined before and during the fabrication of an architectural construct, in order to engineer it with desired properties and functionalities.

In some exemplary implementations of the unit cell 100 as a fuel cell, electrons are transferred as hydrogen is converted to hydrogen ions such as protons, and the electrons are transferred through an external circuit to the opposing electrode to activate the oxidant to react with the hydrogen ions and form water. The chemical potential energy of the reaction is converted to electrical energy by the fuel cell operation. In the reversed mode of electrochemical operation, electrical energy is converted into chemical and/or pressure potential energy of the hydrogen and oxygen inventories that are formed.

FIG. 2 shows a schematic diagram of a unit cell 200, e.g., which can be used in another exemplary embodiment of a multifunctional fuel cell device of the disclosed technology. Similar to the unit cell 100 of FIG. 1, the unit cell 200 includes an electrode pair including the electrode 101 and the electrode 102 coupled to the conduit 111 and the conduit 112, respectively, oriented to be substantially parallel, and separated from each other by a distance. The unit cell 200 also includes one or more inner layered structures of the engineered material spaced between the electrodes (e.g., shown in FIG. 2 as inner boundary component 221) not coupled to the conduits, but coupled to a base structure that is attached to all components of the unit cell (not shown). For example, in some implementations, the base structure can include an electrically insulative and chemically inert material to provide support and/or defining structure to the other components of the exemplary unit cell 200. In the exemplary embodiment shown in FIG. 2, for example, the inner boundary component 221 is oriented substantially parallel to the exemplary electrode orientation of the electrodes 101 and 102.

In some embodiments, for example, the electrodes 101 and 102 and/or the inner boundary component 221 of the unit cell 200 (or other unit cells described herein) can be designed as any suitable three dimensional or curvilinear form (e.g., including tubular forms), e.g., which can be oriented substantially parallel to planar electrode forms and orientation of the electrodes 101 and 102. In some embodiments, the electrodes of the unit cell 200 can be configured as single or multiwall nanotubes of suitable orientations, e.g., such as aligned in parallel to each other and substantially perpendicular to the inner boundary component 221. The exemplary single or multiwall nanotubes of the synthetic crystalline matrix form an electrode layer of the electrodes 101 and/or 102, in which the electrode layer is substantially parallel to the inner boundary component 221. In other embodiments, similar to the unit cell 100, for example, such nanotubes may be one or more randomly oriented stacks of nanotubes to form a sheet-like paper or one or more layers of graphene, in which each side of a graphene sheet can exhibit opposite charge when provided by an applied or generated voltage on the conduits. In some embodiments, for example, the electrodes and/or inner boundary component(s) are made of carbon graphene and/or carbon nanotube foam that can be produced by an exemplary deposition of graphene and/or single or multiwall nanotubes on a suitable metallic precursor, e.g., such as cobalt, nickel or iron foam or fine filament wool. Subsequently, the precursor metal can be utilized as a component of the electrode (and/or inner boundary), or it can be etched away to provide a synthetic carbon-based crystalline matrix.

For example, the reversible charge presented on the facing sides of the electrodes 101 and 102 of the unit cell 200 can be provided by an applied voltage on the conduits 111 and 112, respectively. By applying an electric potential on the opposing electrodes 101 and 102, opposite charges are formed on the sides that generate an electric field between the electrodes 101 and 102. The generated electric field can induce charge on the inner boundary 221 also having opposite charge on each side of the layer sheet in the unit cell structure.

In an illustrative example, a negative electric potential is applied to the conduit 111 of the unit cell 200 and a positive electric potential is applied to the conduit 112 of the unit cell 200. As a result, the electrode 101 presents a negative net charge at its facing surface to the interior of the unit cell 200 and the electrode 102 presents a positive net charge at its facing surface to the interior of the unit cell 200. The opposite net charges presented by the electrodes 101 and 102 (e.g., negative and positive, respectively) generate an electric field that induces the inner boundary 221 to present charge on its facing surfaces. In this example, the inner boundary 221 presents a net positive charge at its facing surface facing the electrode 101 and a net negative charge at its facing surface facing the electrode 102.

For example, fluids containing ions and/or electrolytic substances or media in the spaces or cavities between such charged surfaces of the electrodes and/or the inner boundary component(s) are subjected to ion transport as a result to enable fuel cell or electrolyzer functions. In some implementations, such electrolytic substances can be selected to prevent transport of fuel or oxidant particles or molecules and to resist electron transport. Illustratively, for example, water may serve as an ingredient of an electrolyte that includes acid or base forming agents such as carbon dioxide to form carbonic acid or such as sodium or potassium hydroxide to form their respective hydroxide electrolytes.

FIG. 3 shows a schematic diagram of a unit cell 300, e.g., which can be used in another exemplary embodiment of a multifunctional fuel cell device of the disclosed technology. Similar to the unit cell 100 in FIG. 1, the unit cell 300 includes a plurality of electrode pairs including electrodes 101a and 102a and electrodes 101b and 102b, in which the electrodes 101a and 101b are coupled to the conduit 111 and the electrodes 102a and 102b are coupled to the conduit 112. In the exemplary embodiment shown in FIG. 3, the electrodes of the unit cell 300 are oriented to be substantially parallel and separated from each other by a controllable distance. The unit cell 300 can be operated in a manner similar to that described for the unit cell 100, in which opposing sides of an electrode sheet can exhibit opposite charges, e.g., such as in the case of engineered nanotube arrays and/or graphene structures or other engineered material structures of the electrode and/or conduit structures of the unit cell 300. In some exemplary operations, the electrodes 101a, 102a, 101b, and 102b of the unit cell 300 are configured to electrically interact to present opposite electrical charge along their facing surfaces.

In an illustrative example, a negative electric potential is applied to the conduit 111 of the unit cell 300 and a positive electric potential is applied to the conduit 112 of the unit cell 300. As a result, the electrode 101b presents a negative net charge at its facing surface to that of the electrode 102b, in which the electrode 102b presents a positive net charge at its facing surface to that of the electrode 101b; and similarly, the electrode 101a presents a negative net charge at its facing surface to that of the electrode 102a, in which the electrode 102a presents a positive net charge at its facing surface to that of the electrode 101a. The opposite net charges presented by the facing surfaces of the electrodes 101a with 102a and 101b with 102b (e.g., negative and positive, respectively) can generate an electric field that induces charge on their other faces, as depicted in the inset diagram of FIG. 3. Thus an electrolytic substance in such field orientations provides ion transport from one electrode towards another according to the field strength.

FIG. 4 shows a schematic diagram of an integrated unit cell structure 400 including a plurality of individual unit cells, e.g., in which the integrated unit cell structure 400 can be used in another exemplary embodiment of a multifunctional fuel cell device of the disclosed technology. The unit cell 400 includes multiple, interdigitated unit cells, e.g., such as the unit cell 300. The unit cell 400 includes a plurality of branches of electrodes provided by a plurality of paired conduits, e.g., conduit 111-br1 paired with (at least) conduit 112-br1, and conduit 111-br2 paired with (at least) conduit 112-br2, as shown in FIG. 4. In the exemplary embodiment shown in FIG. 4, the electrodes of the unit cell 400 are oriented to be substantially parallel and separated from each other by a controllable distance. In this exemplary embodiment, the first branch (denoted by br1) includes a plurality of electrode pairs including electrodes 101a-br1 and 102a-br1 and electrodes 101b-br1 and 102b-br1, in which the electrodes 101a-br1 and 101b-br1 are coupled to the conduit 111-br1 and the electrodes 102a-br1 and 102b-br1 are coupled to the conduit 112-br1. Similarly, the second branch (denoted by br2) includes a plurality of electrode pairs including electrodes 101a-br2 and 102a-br2 and electrodes 101b-br2 and 102b-br2, in which the electrodes 101a-br2 and 101b-br2 are coupled to the conduit 111-br1 and the electrodes 102a-br2 and 102b-br2 are coupled to the conduit 112-br1. For example, the interdigitated structure of the unit cell 400 allows inter-branch electrode pairing, e.g., such as electrodes 101a-br1 and 101a-br2 with electrode 102a-br1, and electrodes 102b-br1 and 102b-br2 with electrode 101b-br2, as shown in FIG. 4. The unit cell 400 can also be operated in a manner similar to that described for the unit cell 300, in which opposing sides of an electrode sheet can exhibit opposite charges, e.g., such as in the case of engineered graphene structures or other engineered material structures of the electrode and/or conduit structures of the unit cell 400.

FIG. 5 shows a schematic diagram of an exemplary multifunctional fuel cell device of the disclosed technology. The exemplary multifunctional fuel cell device includes a unit cell structure such as the unit cell 200, which includes the electrodes 101 and 102 coupled to their respective conduits 111 and 112 of each side of the unit cell structure and one or more inner layered structures of the engineered material spaced between the electrodes (e.g., such as inner boundary 221 and inner boundary 222 in this exemplary embodiment). The multifunctional fuel cell device can be configured using the unit cell 200 to form an anode and a cathode on opposite sides (e.g., on the surface) of each electrode within the unit cell structure, in which the anode and cathode side of the electrode is determined by the applied electric charge. By applying an electric potential on the electrodes, the anode and cathode sides are formed, which induce subsequent anodes and cathodes on the adjacent inner boundary components of the unit cell structure. Subsequently, the electrodes and inner boundary components of the unit cell 200 can be operated as a surface to initiate and facilitate chemical reactions. The disclosed multifunctional fuel cell devices, such as the exemplary device shown in FIG. 5, can be configured to contain different electrolytes between the electrodes and/or inner boundaries based on the desired products to be synthesized during operation.

In an illustrative example of operation of the multifunctional fuel cell device, a negative electric potential is applied to the conduit 111 of the device and a positive electric potential is applied to the conduit 112 of the device. As a result, the electrode 101 presents a negative net charge at its facing surface to the interior of the unit cell 200 and the electrode 102 presents a positive net charge at its facing surface to the interior of the unit cell 200. The opposite net charges presented by the electrodes 101 and 102 (e.g., negative and positive, respectively) generate an electric field that induces the inner boundary components 221 and 222 to present charge on its facing surfaces. In this example, the inner boundaries 221 and 222 presents a net positive charge at its facing surface facing the electrode 101 and a net negative charge at its facing surface facing the electrode 102. The multifunctional fuel cell device can contain an electrolyte solution between the electrodes and one or more inner boundary components. For example, the electrolyte (e.g., KOH, as shown in FIG. 5) can be supplied between the electrode 101 and the inner boundary 221, between the inner boundaries 221 and 222, and between the inner boundary 222 and the electrode 102. The applied electric potential across the electrodes 101 and 102 of the conduits 111 and 112 induces oppositely charged sides of the electrodes 101 and 102 to produce a cathode and an anode on the facing side of each electrode, respectively, and generates an electric field that induces the inner boundaries 221 and 222 to produce cathode and anode sides corresponding to the direction of the electric field, as illustrated in FIG. 5. The produced cathodes and anodes convert the electrolyte to (1) chemically react to form a new chemical product and (2) release electrical energy (e.g., charge carriers, such as charged particles, radicals, and ions) in the chemical reaction process to present electrical charge at the electrodes for extraction of an electrical signal by the device. The conversion of the electrolyte occurs in an oxidative process that releases electrons captured at the anode and reduces an oxidant (e.g., such as a non-oxygenated substance, like a halogen) to gain electrons at the cathode. For example, in addition to oxygen, halogens such as fluorine, chlorine, bromine, and iodine are exemplary oxidants that may be utilized with fuels such as hydrogen, methanol or other fuel alcohols, formic acid, ammonia, urea, and various organic acids.

Accordingly the nanoscale electrodes and supporting system can perform as a fuel cell to produce electricity by converting selected fuels and oxidants to lower free-energy compounds. The electricity produced may be utilized relatively locally in a complementary cell in electrolysis mode such as to release hydrogen from acids such as acetic or butyric acids produced by anaerobic digestion. Such hydrogen may be admitted into storage by adsorbants such as nanotubes, multilayers of spaced graphene or to produce hydrides until it is utilized as a fuel in the reversed mode of electrochemical cell operation. Control of the switching of operations from passive or dormant conditions between fuel cell and electrolysis functions may be implemented by way of electrical impetus provided by a photovoltaic, thermoelectric, and/or piezoelectric energy conversions. Illustratively, for example, shining a light beam such as a laser diode can be used to produce photovoltaic electricity that is used to switch a fuel cell “on”, or larger magnitude solar radiation input may be used to drive photovoltaic electricity production for electrolysis operations. Thus the multifunctional purposes may serve in many other new applications and perform many new outcomes.

In some implementations, for example, when an electrolyte in a fluid is dispersed between the electrodes, e.g., such as the electrodes of the unit cells 100, 300, or 400, or dispersed in the interior cavities between the electrodes and the inner boundary components, e.g., such as in the unit cell 200, an electric potential applied at the conduits induces oppositely charged sides of the corresponding electrodes to form a cathode and an anode. This generates an electric field that chemically converts the electrolyte in a redox reaction, in which the redox reaction may be catalyzed by the synthetic crystalline material of the electrodes (and/or inner boundary components), including the engineered separations of such components in such embodiments of the multifunctional fuel cell device. Additionally or alternatively, the redox reaction may be catalyzed by catalyst atoms or molecules (catalysts) such as transition metals (e.g., cobalt, nickel, iron, or copper or platinum group selections) or various intermetallics presented by the electrodes and/or inner boundary components in some embodiments of the multifunctional fuel cell device. In some examples, the catalysts can be presented by the electrodes and/or inner boundary components by being structurally bound to the edge atoms of or interstitially within the layers of the synthetic crystalline matrix. For example, the catalysts can be coated on the surface of the electrodes and/or the inner boundary components. Such redox reactions catalyzed by the structural components of the multifunctional fuel cell device and/or the catalysts cause the release of electrons of constituents present in the electrolyte fluid, in which the electrons are captured at the anode, and reduction of a suitable participant such as a non-oxygen characterized substance, e.g., a halogen, to gain electrons at the cathode. This overall process thereby produces a chemical product and extracts energy from constituents of the process reaction or electrolyte composition. Illustratively, for example, various reactants may be utilized that are produced by aerobic or anaerobic digestion including hydrogen carbon dioxide to produce formic acid, methanol, or other alcohols.

For example, in some implementations of the multifunctional fuel cell device, the device can be operated as an electrolyzer to produce the electrolyte within the unit cell by adding ion-forming constituents or compounds and adding or producing water (e.g., such as described in Eq. 1) to make the electrolyte for use in the fuel cell functionality. For example, sodium or potassium can be added (e.g., coated) to the layer structures of the unit cell, and water can be subsequently added. An electric potential can be applied to the electrodes of the unit cell to produce sodium hydroxide (NaOH) or potassium hydroxide (KOH) formed within the unit cell, respectively, to serve as the electrolyte for the fuel cell. Additionally, the polarity of the electric potential applied to the electrodes of the unit cell can be reversed to discharge and recharge the unit cell for as a reversible fuel cell device, e.g., in which the reversed polarity can induce the formed KOH or NaOH to release hydrogen (e.g., either stored in captivity in a suitable form such as an acid or base or kept as water), and the potassium or sodium constituents are formed on the electrodes of the unit cell. For example, oxygen can be extracted in such instances, which can be used for pressurization and/or released from the device. In other examples, calcium can be added to the layer structures such that calcium hydroxide (CaOH) can be formed within the unit cell.

In some implementations, for example, the multifunctional fuel cell device can be operated to produce a nitrogen or carbon-based fuel substance (e.g., ammonia, urea, formic acid, methanol, ethanol, or other alcohol) that can be collected as used in another process (e.g., such as a compact hydrogen carrier or a combustion process). FIGS. 6A-6E show illustrative schematic diagrams of a method to produce a fuel (e.g., methanol) using a multifunctional fuel cell device containing a simple, abundant substance such as water as the electrolyte solution between the electrodes (and/or the inner boundary components) of the fuel cell's unit cell. For example, the exemplary fuel cell device can be used to (reversibly) produce methanol and oxygen from the water electrolyte and a controllably-supplied carbon dioxide reactant, e.g., by facilitating the reaction shown in Equation 2.

CO₂+2H₂O [symbol] CH₃OH+1.5O₂ (Eq. 2)

The method includes a process to supply water as an electrolyte to the interior cavities of the multifunctional fuel cell 600 (e.g., having the unit cell structure 200 in this exemplary embodiment), as depicted in FIG. 6A. The layers of the engineered material forming at least one of the electrodes 101 and/or 102 can be configured to store a reactant substance 610 (e.g., CO₂) between its layers and controllably release the reactant substance 610 (e.g., release the CO₂) upon activation, e.g., by an applied electric potential on the electrodes 101 and/or 102 via the conduits 111 and/or 112, respectively. In some implementations, the method includes a process to apply an electrical potential at one conduit to controllably-release the loaded reactant substance 610 from one of the electrodes into the electrolyte contained in the first interior cavity between the electrode 101 and the inner boundary 221, e.g., as depicted in FIG. 6B, where an electric potential is applied at conduit 111 to release the exemplary CO₂ into the electrolyte from the electrode 101. The method includes a process to apply an electric potential at the conduits 111 and 112 to produce a cathode and an anode on the interior facing sides of the electrodes 101 and 102, respectively, and to generate an electric field that induces the inner boundary 221 to produce cathode and anode sides corresponding to the direction of the electric field of the multifunctional fuel cell 600, as depicted in FIG. 6C. The applied electrical energy causes the exemplary reactant, e.g., CO₂, to react with the water electrolyte in the first interior cavity to produce intermediary products, e.g., including CO, O₂, and H₂O₂, as depicted in FIG. 6D. The method can be implemented to provide the net reaction shown in Equation 2. The method includes a process to selectively transfer one or more of the produced intermediary products through the inner boundary 221 from the first interior cavity to the second interior cavity between the electrode 102 and the inner boundary 221. For example, due to the selective properties of the engineered material that forms the inner boundary 221, e.g., such as aligned single or multiwall nanotubes or paper type arrays of nanotubes and/or functionalized graphene, the produced intermediary product CO can be selectively transferred through the inner boundary 221 to the second interior cavity, e.g., as depicted in FIG. 6D. For example, selective transfers may be provided by the separation distance between adjacent layers of graphene, by holes or apertures in graphene layers or other functionalizations. Similarly the space within the inside diameters and/or the space between single and/or multiwall nanotubes may be utilized to separate components by size, orientation, surface tension, charge, or shape distinctions. The applied electrical energy at the electrodes 101 and 102 to produce the cathode and anode on the interior facing surfaces of the electrodes (and subsequently the produced anode and cathode surfaces of the inner boundary 221) causes the selectively transferred intermediary product(s), e.g., CO in this example, to react with the water electrolyte in the second interior cavity to produce the final products, e.g., including CH₃OH and O₂, as depicted in FIG. 6E.

In some implementations of the method to produce the fuel using the multifunctional fuel cell device, the method includes a process to collect the produced fuel and/or by-products. For example, phase separation, e.g., gaseous oxygen separation from condensed methanol improves the reaction efficiency by shifting the equilibrium towards the product. In some examples, the process to collect the produced methanol can also include filtering the methanol from the second interior cavity out of the device 600. In some examples, the process to collect the produced oxygen can include selectively transfer of the oxygen through the engineered material of the electrode 102 from the second interior cavity to a collection chamber within the base structure 601 of the device 600 or fluidically coupled to the device 600.

The disclosed multifunctional fuel cell technology enables the ability to carry out reversible chemical reactions to produce desired products and extract energy from such reversible reactions. The disclosed multifunctional fuel cell technology also enables the ability to carry a chemical reaction to produce multiple outcomes from an initial group of reactants, such as that characterized by Equation 3. For example, one desired outcome (e.g., a first group of products “B”, in Equation 3) can be produced by an initial reactant group (e.g., “A”, in Equation 3) and the first group of products “B” can subsequently be used to carry out another chemical reaction to produce a second desired outcome (e.g., a second group of products “C”, in Equation 3).

$$\begin{matrix}A & ⇋ \\ C & ⇋\end{matrix} B \qquad ( Eq . 3 )$$

The disclosed multifunctional fuel cell devices can be loaded with different feedstocks, e.g., feedstocks loaded within the layers of the engineered materials forming the electrodes and/or the inner boundary components, as well as one or more electrolyte feedstocks, to produce the desired outcomes (e.g., synthesized products and extracted energy). For example, the multifunctional fuel cell devices can be used to produce durable goods, e.g., such as polyvinyl halogen products, based on the electrolyte (e.g., such as HF, HCl, HBr, HI from suitable precursors and/or reactants) and one or more reactant substances loaded in the engineered material forming the electrodes and/or inner boundary components. The disclosed multifunctional fuel cell devices can be operated with various electrical potentials, e.g., in which the amplitude, frequency, timing of application, and location of application, to produce the desired outcomes (e.g., synthesized products and extracted energy). Additionally, for example, the disclosed multifunctional fuel cell devices can be operated with other external parameters to produce the desired outcomes, e.g., such as controlling temperature, magnetism, or other parameters during implementation of the multifunctional fuel cell device. For example, energy conversion such as radiant energy addition to produce heat and elevated temperature can increase the vapor pressure and/or rate of oxygen or halogen release in conjunction with electrolysis.

Applications of the disclosed multifunctional fuel cell devices are virtually limitless on both the large scale and small scale. For example, the multifunctional fuel cell devices can be used on a large scale in agricultural and/or industrial applications to convert waste (e.g., biomass waste of agricultural processes) into fuels that can be cycled back into industrial and/or agricultural processes. Also, for example, the multifunctional fuel cell devices can be used on a large scale to transport energy and/or fuel from one location to another. For example, the multifunctional fuel cell devices can be used on a large scale to repurpose carbon produced by the melting of permafrost into useful purposes that do not contribute to accumulation of greenhouse gases and global warming. Additionally, the multifunctional fuel cell devices can be used on a small scale to power small-scale devices such as sensors, actuators, and other devices or provide and/or collect chemical fuel to/from such small-scale devices as the sensors, actuators, and other devices. In some implementations, the disclosed multifunctional fuel cell devices can be operatively coupled to systems or devices and used in methods described in U.S. Pat. No. 8,312,759 B2 entitled “METHODS, DEVICES, AND SYSTEMS FOR DETECTING PROPERTIES OF TARGET SAMPLES” and U.S. Patent Publication US2014/0046494 A1 entitled “DYNAMIC SENSORS”, both of which are incorporated by reference in their entirety as part of the disclosure in this patent document.

In some aspects of the disclosed technology, a method to produce a multifunctional fuel cell device can include a process to dissociate a feedstock substance including a gas or a vapor into constituents, e.g., which can include individual atoms and/or molecules. The method can include a process to deposit the constituents on a surface, e.g., including one or more surfaces of a target substrate, in which the constituents are deposited at one or more particular locations on the surface, and along multiple surfaces of the substrate, e.g., to produce the unit cell structure (e.g., such as that in the unit cell 100, 200, 300, and 400). The method can include a process to grow layers, e.g., layer by layer, using two or more precision energy beams to form the desired material structure of the unit cell, e.g., in which the energy beams include at least one of a laser beam or an electron beam.

In some implementations, the method can first be implemented to produce a storage region of the fuel cell device and then be implemented to produce electrodes of the fuel cell device. For example, exemplary fuel cell devices produced using the disclosed methods can be oriented such that it is capable to provide for pressure containment. In some examples, the fabricated fuel cell device can include graphene structures, which can be used, for example, as (1) a heat sink to add or remove heat for rapid reversible cycles, and (2) catalysts, in which the graphene structure facilitates rapid adsorption and/or release of other molecules to react in the structure. In some examples, the fabricated fuel cell device can include electrodes having an exemplary stacked-electrode configuration, which can allow for 9000 m² of electrode surface area for every 1 cm³ of the device. For example, the large surface area of the electrodes can provide for more efficient catalysts and better heat transfer. Additionally, for example, deposits (e.g., mica) can be added to the electrodes to control dielectric constants of the device. Also, for example, the electrodes can be used for heat transfer and for storing substances (e.g., gases). In some examples, the fabricated fuel cell device can include electrolytes that form precursors, in which the electrolytes are operated at any desired temperature, including low, medium and high temperatures, e.g., depending on the application of the exemplary fuel cell device.

Other exemplary methods to produce engineered materials and electrochemical devices of the disclosed technology include those described in the PCT Patent application PCT/US14/30725 entitled “METHODS OF MANUFACTURE OF ENGINEERED MATERIALS AND DEVICES,” and filed on Mar. 17, 2014, and U.S. application Ser. No. 14/217,055 entitled “METHODS OF MANUFACTURE OF ENGINEERED MATERIALS AND DEVICES,” and filed on Mar. 17, 2014, both of which are incorporated by reference in their entirety as part of the disclosure in this patent document.

In some embodiments, for example, a multifunctional fuel cell device includes a first electrode and a second electrode separated by a distance and aligned substantially in parallel, a first conduit and a second conduit coupled to the first electrode and the second electrode, respectively, substantially perpendicular to the electrodes, in which the configuration of the first and second electrodes and the first and second conduits form a unit cell structure, and a fluid including an electrolyte and a non-oxygenated substance, the fluid dispersed between the electrodes, in which an applied electric potential across the first and second conduits induces oppositely charged sides of the first and second electrodes to form a cathode and an anode side of each electrode, the applied electric field converting the electrolyte in an oxidative process that releases electrons captured at the anode and reducing a non-oxygenated substance to gain electrons at the cathode, thereby extracting energy from the electrolyte.

The following examples are illustrative of several embodiments of the present technology. Other exemplary embodiments of the present technology may be presented prior to the following listed examples, or after the following listed examples.

In one example of the present technology (example 1), an electrochemical device includes a first electrode and a second electrode separated by a distance and aligned substantially in parallel; and a first conduit and a second conduit connected and electrically coupled to the first electrode and the second electrode, respectively, substantially perpendicular to the electrodes, in which the configuration of the first and second electrodes and the first and second conduits form a unit cell structure, in which, when a fluid comprising an electrolyte and a non-oxygenated substance is dispersed between the first and second electrodes, an electric potential applied across the first and second conduits induces oppositely charged sides of the first and second electrodes to form a cathode side and an anode side of the corresponding electrode, and generates an electric field converting the electrolyte in an oxidative process that releases electrons captured at the anode and reducing the non-oxygenated substance to gain electrons at the cathode, thereby producing a chemical product and extracting energy from the electrolyte.

Example 2 includes the electrochemical device of example 1, further including a housing structure formed of a chemically inert and electrically insulative material coupled to the first and second conduits and enclosing the unit cell structure.

Example 3 includes the electrochemical device of example 2, further including an interior boundary coupled to the housing structure and arranged substantially in parallel between the first and second electrodes.

Example 4 includes the electrochemical device of example 1, in which one or both of the first and second electrodes are formed of one or more layers of a synthetic crystalline material.

Example 5 includes the electrochemical device of example 4, in which one or both of the first and second conduits are formed of one or more layers of the synthetic crystalline material.

Example 6 includes the electrochemical device of example 4, in which the synthetic crystalline material is structured to include one or both of interstitial and edge dopant atoms or molecules to affect the electrical conductivity of the electrodes.

Example 7 includes the electrochemical device of example 1, further including a third electrode and a fourth electrode separated by a particular distance and aligned substantially in parallel, in which the third electrode is coupled to the first conduit and spaced apart from the first electrode on the first conduit, and in which the fourth electrode is coupled to the second conduit and spaced apart from the second electrode on the second conduit.

Example 8 includes the electrochemical device of example 6, in which the electrodes are interdigitated such that the third electrode is arranged between the second and the third electrode.

Example 9 includes the electrochemical device of example 1, further including a third electrode and a fourth electrode separated by a particular distance and aligned substantially in parallel; and a third conduit and a fourth conduit coupled to the third electrode and the fourth electrode, respectively, substantially perpendicular to the third and fourth electrodes, in which the third conduit is arranged proximate the first conduit at a spacing such that the third electrode and the first electrode are not in contact, and in which the fourth conduit is arranged proximate the second conduit at a spacing such that the fourth electrode and the second electrode are not in contact.

Example 10 includes the electrochemical device of example 8, in which the electrodes are interdigitated such that the third electrode is arranged between the second conduit and the fourth conduit.

In another example of the present technology (example 11), an electrochemical device includes a first electrode and a second electrode separated by a distance and aligned substantially in parallel; a first conduit and a second conduit connected and electrically coupled to the first electrode and the second electrode, respectively, substantially perpendicular to the electrodes, in which the configuration of the first and second electrodes and the first and second conduits form a unit cell structure; and a non-oxygenated substance coupled to the first electrode, in which, when an electrolyte in a fluid is between the first and second electrodes, an electric potential applied across the first and second conduits induces oppositely charged sides of the first and second electrodes to form a cathode and an anode, respectively, and generates an electric field converting the electrolyte in an oxidative process that releases electrons captured at the anode and reducing the non-oxygenated substance to gain electrons at the cathode, thereby producing a chemical product and extracting energy from the electrolyte.

Example 12 includes the electrochemical device of example 11, further including a housing structure formed of a chemically inert and electrically insulative material coupled to the first and second conduits and enclosing the unit cell structure.

Example 13 includes the electrochemical device of example 12, further including an interior boundary coupled to the housing structure and arranged substantially in parallel between the first and second electrodes.

Example 14 includes the electrochemical device of example 11, in which one or both of the first and second electrodes are formed of one or more layers of a synthetic crystalline material.

Example 15 includes the electrochemical device of example 14, in which one or both of the first and second conduits are formed of one or more layers of the synthetic crystalline material.

Example 16 includes the electrochemical device of example 14, in which the synthetic crystalline material is structured to include one or both of interstitial and edge dopant atoms or molecules to affect the electrical conductivity of the electrodes.

Example 17 includes the electrochemical device of example 11, in which the non-oxygenated substance is coated on the first electrode.

Example 18 includes the electrochemical device of example 17, in which the electrolyte of the fluid includes water and the non-oxygenated substance includes at least one of an alkali metal-halogen salt or alkaline earth metal-halogen salt, such that the applied electric potential, prior to producing the chemical product and extracting the energy, generates a second electrolyte including at least one of an alkali metal hydroxide or alkaline earth metal hydroxide by causing a chemical reaction of the water with the non-oxygenated substance.

Example 19 includes the electrochemical device of example 11, in which, when the electric potential is applied with reversed polarity, the produced chemical product dissociates to at least the non-oxygenated substance and the electrolyte releases hydrogen.

Example 20 includes the electrochemical device of example 19, in which the electrolyte includes at least one of an alkali metal hydroxide or alkaline earth metal hydroxide and the non-oxygenated substance includes at least one of an alkali metal-halogen or alkaline earth metal-halogen compound.

In another example of the present technology (example 21), an electrochemical device, includes a first electrode and a second electrode separated by a distance and aligned substantially in parallel, in which the first and second electrodes are formed of one or more layers of a synthetic crystalline material; and a first conduit and a second conduit connected and electrically coupled to the first electrode and the second electrode, respectively, substantially perpendicular to the electrodes, in which the configuration of the first and second electrodes and the first and second conduits form a unit cell structure, in which, when an electrolytic fluid is between the first and second electrodes, an electric potential applied across the first and second conduits induces oppositely charged sides of the first and second electrodes to form a cathode and an anode, respectively, and generates an electric field that converts constituents of the electrolytic fluid in a redox reaction catalyzed by the synthetic crystalline material of the first and second electrodes to cause oxidation of a reducing agent constituent to lose electrons captured at the anode and reduction of an oxidant to gain electrons at the cathode, thereby producing a chemical product and extracting energy from the electrolytic fluid.

Example 22 includes the electrochemical device of example 21, further including a housing structure formed of a chemically inert and electrically insulative material coupled to the first and second conduits and enclosing the unit cell structure.

Example 23 includes the electrochemical device of example 22, further including an interior boundary coupled to the housing structure and arranged substantially in parallel between the first and second electrodes.

Example 24 includes the electrochemical device of example 23, in which the interior boundary is formed of one or more layers of the synthetic crystalline material.

Example 25 includes the electrochemical device of example 21, in which one or both of the first and second conduits are formed of one or more layers of the synthetic crystalline material.

Example 26 includes the electrochemical device of example 21, in which the synthetic crystalline material is structured to include one or both of interstitial and edge dopant atoms or molecules to affect the electrical conductivity of the electrodes.

Example 27 includes the electrochemical device of example 21, in which the oxidant is coated on the first electrode.

Example 28 includes the electrochemical device of example 27, in which the electrolytic fluid includes water and the oxidant includes at least one of an alkali metal-halogen salt or alkaline earth metal-halogen salt, such that the applied electric potential, prior to producing the chemical product and extracting the energy, generates a second electrolyte comprising at least one of an alkali metal hydroxide or alkaline earth metal hydroxide by causing a chemical reaction of the water with the non-oxygenated substance.

Example 29 includes the electrochemical device of example 21, in which, when the electric potential is applied with reversed polarity, the produced chemical product dissociates to at least the oxidant constituent and hydrogen.

Example 30 includes the electrochemical device of example 29, in which the electrolytic fluid includes at least one of an alkali metal hydroxide or alkaline earth metal hydroxide, and the oxidant constituent includes at least one of an alkali metal-halogen or alkaline earth metal-halogen compound.

In another example of the present technology (example 31), a method to produce a fuel substance and electrical energy includes supply water as an electrolyte to two or more interior cavities of an electrochemical device. The electrochemical device is structured to include a first electrode and a second electrode separated by a distance and aligned substantially in parallel, in which the first and second electrodes are formed of one or more layers of a synthetic crystalline material, a first conduit and a second conduit connected and electrically coupled to the first electrode and the second electrode, respectively, substantially perpendicular to the electrodes, a housing structure formed of a chemically inert and electrically insulative material coupled to the first and second conduits and enclosing the first and second electrodes, and two or more interior boundary walls coupled to the housing structure and arranged substantially in parallel between the first and second electrodes to form the two or more interior cavities. The method to produce a fuel substance and electrical energy includes releasing a reactant substance through the one or more layers of the synthetic crystalline material of the first electrode into a first interior cavity of the two or more interior cavities. The method to produce a fuel substance and electrical energy includes applying a electric potential at the first and second conduits to produce intermediary chemical products, in which the applied electric potential generates an electric field across the first and second electrodes to form a cathode and an anode and cause chemical conversion of the released reactant substance and the electrolyte in the first interior cavity catalyzed by the synthetic crystalline material of the first electrode. The method to produce a fuel substance and electrical energy includes selectively transferring at least one of the produced intermediary chemical products to a second interior cavity of the two or more interior cavities. In the method to produce a fuel substance and electrical energy, the generated electric field causes chemical conversion of the selectively transferred reactant substance and the electrolyte in the second interior cavity catalyzed by the synthetic crystalline material of the second electrode to produce a chemical fuel, in which the chemical conversions release electrical charge carriers extracted as electrical energy at the electrodes.

Example 32 includes the method of example 31, in which the reactant substance includes carbon dioxide.

Example 33 includes the method of example 32, in which the carbon dioxide is stored in the one or more layers of the synthetic crystalline material.

Example 34 includes the method of example 31, in which the intermediary chemical products include one or more of carbon monoxide (CO), oxygen gas (O₂), and hydrogen peroxide (H₂O₂).

Example 35 includes the method of example 34, in which the carbon monoxide is selectively transferred to the second interior cavity.

Example 36 includes the method of example 31, in which the chemical fuel includes methanol (CH₃OH).

Example 37 includes the method of example 36, further including collecting the methanol from the second interior cavity to a collection chamber.

Example 38 includes the method of example 36, in which oxygen gas (O₂) is produced along with the methanol in the second interior cavity.

Example 39 includes the method of example 38, further including collecting the oxygen gas from the second interior cavity to a collection chamber.

Example 40 includes the method of example 31, in which the two or more interior boundary walls are formed of one or more layers of the synthetic crystalline material, and in which at least one of the produced intermediary chemical products is selectively transferred to the second interior cavity through the inner boundary wall.

In another example of the present technology (example 41), an electrochemical device includes a first electrode and a second electrode separated by a distance and aligned substantially in parallel, in which the first and second electrodes are formed of one or more layers of a synthetic crystalline material; and a first conduit and a second conduit connected and electrically coupled to the first electrode and the second electrode, respectively, substantially perpendicular to the electrodes, in which the configuration of the first and second electrodes and the first and second conduits form a unit cell structure, in which an applied electrical potential across the first and second electrodes produces a chemical product and extracts energy from an electrolyte when supplied between the first and second electrodes.

Example 42 includes the electrochemical device of example 41, in which the applied electric potential induces oppositely charged sides of the first and second electrodes to form a cathode and an anode, respectively, and generates an electric field that converts constituents of the electrolyte in a redox reaction to cause oxidation of a reducing agent to lose electrons captured at the anode and reduction of an oxidant to gain electrons at the cathode, thereby producing the chemical product and the extracted energy.

Example 43 includes the electrochemical device of example 42, in which the redox reaction is catalyzed by the synthetic crystalline material of the first and second electrodes.

Example 44 includes the electrochemical device of example 41, further including a housing structure formed of a chemically inert and electrically insulative material coupled to the first and second conduits and enclosing the unit cell structure.

Example 45 includes the electrochemical device of example 44, further including an interior boundary coupled to the housing structure and arranged substantially in parallel between the first and second electrodes.

Example 46 includes the electrochemical device of example 45, in which the interior boundary is formed of one or more layers of the synthetic crystalline material.

Example 47 includes the electrochemical device of example 41, in which one or both of the first and second conduits are formed of one or more layers of the synthetic crystalline material.

Example 48 includes the electrochemical device of example 41, in which the synthetic crystalline material is structured to include one or both of interstitial and edge dopant atoms or molecules to affect the electrical conductivity of the electrodes.

Example 49 includes the electrochemical device of example 41, in which the reducing agent is coated on the second electrode.

Example 50 includes the electrochemical device of example 41, in which the oxidant is coated on the first electrode.

Example 51 includes the electrochemical device of example 50, in which the electrolyte includes water and the oxidant includes at least one of an alkali metal-halogen salt or alkaline earth metal-halogen salt, such that the applied electric potential, prior to producing the chemical product and extracting the energy, generates a second electrolyte comprising at least one of an alkali metal hydroxide or alkaline earth metal hydroxide by causing a chemical reaction of the water with the non-oxygenated substance.

Example 52 includes the electrochemical device of example 41, in which, when the electric potential is applied with reversed polarity, the produced chemical product dissociates to at least the oxidant constituent and hydrogen.

Example 53 includes the electrochemical device of example 52, in which the electrolyte includes at least one of an alkali metal hydroxide or alkaline earth metal hydroxide, and the oxidant constituent includes at least one of an alkali metal-halogen or alkaline earth metal-halogen compound.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

I/We claim:

1. An electrochemical device, comprising:
a first electrode and a second electrode separated by a distance and aligned substantially in parallel; and
a first conduit and a second conduit connected and electrically coupled to the first electrode and the second electrode, respectively, substantially perpendicular to the electrodes, wherein the configuration of the first and second electrodes and the first and second conduits form a unit cell structure,
wherein, when a fluid comprising an electrolyte and a non-oxygenated substance is dispersed between the first and second electrodes, an electric potential applied across the first and second conduits induces oppositely charged sides of the first and second electrodes to form a cathode side and an anode side of the corresponding electrode, and generates an electric field converting the electrolyte in an oxidative process that releases electrons captured at the anode and reducing the non-oxygenated substance to gain electrons at the cathode, thereby producing a chemical product and extracting energy from the electrolyte.

2. The electrochemical device of claim 1, further comprising:
a housing structure formed of a chemically inert and electrically insulative material coupled to the first and second conduits and enclosing the unit cell structure.

3. The electrochemical device of claim 2, further comprising:
an interior boundary coupled to the housing structure and arranged substantially in parallel between the first and second electrodes.

4. The electrochemical device of claim 1, wherein one or both of the first and second electrodes are formed of one or more layers of a synthetic crystalline material.

5. The electrochemical device of claim 4, wherein one or both of the first and second conduits are formed of one or more layers of the synthetic crystalline material.

6. The electrochemical device of claim 4, wherein the synthetic crystalline material is structured to include one or both of interstitial and edge dopant atoms or molecules to affect the electrical conductivity of the electrodes.

7. The electrochemical device of claim 1, further comprising:
a third electrode and a fourth electrode separated by a particular distance and aligned substantially in parallel,
wherein the third electrode is coupled to the first conduit and spaced apart from the first electrode on the first conduit, and wherein the fourth electrode is coupled to the second conduit and spaced apart from the second electrode on the second conduit.

8. The electrochemical device of claim 6, wherein the electrodes are interdigitated such that the third electrode is arranged between the second and the third electrode.

9. The electrochemical device of claim 1, further comprising:
a third electrode and a fourth electrode separated by a particular distance and aligned substantially in parallel; and
a third conduit and a fourth conduit coupled to the third electrode and the fourth electrode, respectively, substantially perpendicular to the third and fourth electrodes,
wherein the third conduit is arranged proximate the first conduit at a spacing such that the third electrode and the first electrode are not in contact, and wherein the fourth conduit is arranged proximate the second conduit at a spacing such that the fourth electrode and the second electrode are not in contact.

10. The electrochemical device of claim 8, wherein the electrodes are interdigitated such that the third electrode is arranged between the second conduit and the fourth conduit.

11. An electrochemical device, comprising:
a first electrode and a second electrode separated by a distance and aligned substantially in parallel;
a first conduit and a second conduit connected and electrically coupled to the first electrode and the second electrode, respectively, substantially perpendicular to the electrodes, wherein the configuration of the first and second electrodes and the first and second conduits form a unit cell structure; and
a non-oxygenated substance coupled to the first electrode,
wherein, when an electrolyte in a fluid is between the first and second electrodes, an electric potential applied across the first and second conduits induces oppositely charged sides of the first and second electrodes to form a cathode and an anode, respectively, and generates an electric field converting the electrolyte in an oxidative process that releases electrons captured at the anode and reducing the non-oxygenated substance to gain electrons at the cathode, thereby producing a chemical product and extracting energy from the electrolyte.

12. The electrochemical device of claim 11, further comprising:
a housing structure formed of a chemically inert and electrically insulative material coupled to the first and second conduits and enclosing the unit cell structure.

13. The electrochemical device of claim 12, further comprising:
an interior boundary coupled to the housing structure and arranged substantially in parallel between the first and second electrodes.

14. The electrochemical device of claim 11, wherein one or both of the first and second electrodes are formed of one or more layers of a synthetic crystalline material.

15. The electrochemical device of claim 14, wherein one or both of the first and second conduits are formed of one or more layers of the synthetic crystalline material.

16. The electrochemical device of claim 14, wherein the synthetic crystalline material is structured to include one or both of interstitial and edge dopant atoms or molecules to affect the electrical conductivity of the electrodes.

17. The electrochemical device of claim 11, wherein the non-oxygenated substance is coated on the first electrode.

18. The electrochemical device of claim 17, wherein the electrolyte of the fluid includes water and the non-oxygenated substance includes at least one of an alkali metal-halogen salt or alkaline earth metal-halogen salt, such that the applied electric potential, prior to producing the chemical product and extracting the energy, generates a second electrolyte comprising at least one of an alkali metal hydroxide or alkaline earth metal hydroxide by causing a chemical reaction of the water with the non-oxygenated substance.

19. The electrochemical device of claim 11, wherein, when the electric potential is applied with reversed polarity, the produced chemical product dissociates to at least the non-oxygenated substance and the electrolyte releases hydrogen.

20. The electrochemical device of claim 19, wherein the electrolyte includes at least one of an alkali metal hydroxide or alkaline earth metal hydroxide and the non-oxygenated substance includes at least one of an alkali metal-halogen or alkaline earth metal-halogen compound.

21. An electrochemical device, comprising:
a first electrode and a second electrode separated by a distance and aligned substantially in parallel, wherein the first and second electrodes are formed of one or more layers of a synthetic crystalline material; and
a first conduit and a second conduit connected and electrically coupled to the first electrode and the second electrode, respectively, substantially perpendicular to the electrodes, wherein the configuration of the first and second electrodes and the first and second conduits form a unit cell structure,
wherein, when an electrolytic fluid is between the first and second electrodes, an electric potential applied across the first and second conduits induces oppositely charged sides of the first and second electrodes to form a cathode and an anode, respectively, and generates an electric field that converts constituents of the electrolytic fluid in a redox reaction catalyzed by the synthetic crystalline material of the first and second electrodes to cause oxidation of a reducing agent constituent to lose electrons captured at the anode and reduction of an oxidant to gain electrons at the cathode, thereby producing a chemical product and extracting energy from the electrolytic fluid.

22. The electrochemical device of claim 21, further comprising:
a housing structure formed of a chemically inert and electrically insulative material coupled to the first and second conduits and enclosing the unit cell structure.

23. The electrochemical device of claim 22, further comprising:
an interior boundary coupled to the housing structure and arranged substantially in parallel between the first and second electrodes.

24. The electrochemical device of claim 23, wherein the interior boundary is formed of one or more layers of the synthetic crystalline material.

25. The electrochemical device of claim 21, wherein one or both of the first and second conduits are formed of one or more layers of the synthetic crystalline material.

26. The electrochemical device of claim 21, wherein the synthetic crystalline material is structured to include one or both of interstitial and edge dopant atoms or molecules to affect the electrical conductivity of the electrodes.

27. The electrochemical device of claim 21, wherein the oxidant is coated on the first electrode.

28. The electrochemical device of claim 27, wherein the electrolytic fluid includes water and the oxidant includes at least one of an alkali metal-halogen salt or alkaline earth metal-halogen salt, such that the applied electric potential, prior to producing the chemical product and extracting the energy, generates a second electrolyte comprising at least one of an alkali metal hydroxide or alkaline earth metal hydroxide by causing a chemical reaction of the water with the non-oxygenated substance.

29. The electrochemical device of claim 21, wherein, when the electric potential is applied with reversed polarity, the produced chemical product dissociates to at least the oxidant constituent and hydrogen.

30. The electrochemical device of claim 29, wherein the electrolytic fluid includes at least one of an alkali metal hydroxide or alkaline earth metal hydroxide, and the oxidant constituent includes at least one of an alkali metal-halogen or alkaline earth metal-halogen compound.

31. A method to produce a fuel substance and electrical energy, comprising:
supply water as an electrolyte to two or more interior cavities of an electrochemical device structured to include:
a first electrode and a second electrode separated by a distance and aligned substantially in parallel, wherein the first and second electrodes are formed of one or more layers of a synthetic crystalline material,
a first conduit and a second conduit connected and electrically coupled to the first electrode and the second electrode, respectively, substantially perpendicular to the electrodes,
a housing structure formed of a chemically inert and electrically insulative material coupled to the first and second conduits and enclosing the first and second electrodes, and
two or more interior boundary walls coupled to the housing structure and arranged substantially in parallel between the first and second electrodes to form the two or more interior cavities;
releasing a reactant substance through the one or more layers of the synthetic crystalline material of the first electrode into a first interior cavity of the two or more interior cavities;
applying a electric potential at the first and second conduits to produce intermediary chemical products, wherein the applied electric potential generates an electric field across the first and second electrodes to form a cathode and an anode and cause chemical conversion of the released reactant substance and the electrolyte in the first interior cavity catalyzed by the synthetic crystalline material of the first electrode;
selectively transferring at least one of the produced intermediary chemical products to a second interior cavity of the two or more interior cavities;
wherein the generated electric field causes chemical conversion of the selectively transferred reactant substance and the electrolyte in the second interior cavity catalyzed by the synthetic crystalline material of the second electrode to produce a chemical fuel,
wherein the chemical conversions release electrical charge carriers extracted as electrical energy at the electrodes.

32. The method of claim 31, wherein the reactant substance includes carbon dioxide.

33. The method of claim 32, wherein the carbon dioxide is stored in the one or more layers of the synthetic crystalline material.

34. The method of claim 31, wherein the intermediary chemical products include one or more of carbon monoxide (CO), oxygen gas (O₂), and hydrogen peroxide (H₂O₂).

35. The method of claim 34, wherein the carbon monoxide is selectively transferred to the second interior cavity.

36. The method of claim 31, wherein the chemical fuel includes methanol (CH₃OH).

37. The method of claim 36, further comprising:
collecting the methanol from the second interior cavity to a collection chamber.

38. The method of claim 36, wherein oxygen gas (O₂) is produced along with the methanol in the second interior cavity.

39. The method of claim 38, further comprising:
collecting the oxygen gas from the second interior cavity to a collection chamber.

40. The method of claim 31, wherein the two or more interior boundary walls are formed of one or more layers of the synthetic crystalline material, and wherein at least one of the produced intermediary chemical products is selectively transferred to the second interior cavity through the inner boundary wall.

41. An electrochemical device, comprising:
a first electrode and a second electrode separated by a distance and aligned substantially in parallel, wherein the first and second electrodes are formed of one or more layers of a synthetic crystalline material; and
a first conduit and a second conduit connected and electrically coupled to the first electrode and the second electrode, respectively, substantially perpendicular to the electrodes, wherein the configuration of the first and second electrodes and the first and second conduits form a unit cell structure;
wherein an applied electrical potential across the first and second electrodes produces a chemical product and extracts energy from an electrolyte when supplied between the first and second electrodes.

42. The electrochemical device of claim 41, wherein the applied electric potential induces oppositely charged sides of the first and second electrodes to form a cathode and an anode, respectively, and generates an electric field that converts constituents of the electrolyte in a redox reaction to cause oxidation of a reducing agent to lose electrons captured at the anode and reduction of an oxidant to gain electrons at the cathode, thereby producing the chemical product and the extracted energy.

43. The electrochemical device of claim 42, wherein the redox reaction is catalyzed by the synthetic crystalline material of the first and second electrodes.

44. The electrochemical device of claim 41, further comprising:
a housing structure formed of a chemically inert and electrically insulative material coupled to the first and second conduits and enclosing the unit cell structure.

45. The electrochemical device of claim 44, further comprising:
an interior boundary coupled to the housing structure and arranged substantially in parallel between the first and second electrodes.

46. The electrochemical device of claim 45, wherein the interior boundary is formed of one or more layers of the synthetic crystalline material.

47. The electrochemical device of claim 41, wherein one or both of the first and second conduits are formed of one or more layers of the synthetic crystalline material.

48. The electrochemical device of claim 41, wherein the synthetic crystalline material is structured to include one or both of interstitial and edge dopant atoms or molecules to affect the electrical conductivity of the electrodes.

49. The electrochemical device of claim 41, wherein the reducing agent is coated on the second electrode.

50. The electrochemical device of claim 41, wherein the oxidant is coated on the first electrode.

51. The electrochemical device of claim 50, wherein the electrolyte includes water and the oxidant includes at least one of an alkali metal-halogen salt or alkaline earth metal-halogen salt, such that the applied electric potential, prior to producing the chemical product and extracting the energy, generates a second electrolyte comprising at least one of an alkali metal hydroxide or alkaline earth metal hydroxide by causing a chemical reaction of the water with the non-oxygenated substance.

52. The electrochemical device of claim 41, wherein, when the electric potential is applied with reversed polarity, the produced chemical product dissociates to at least the oxidant constituent and hydrogen.

53. The electrochemical device of claim 52, wherein the electrolyte includes at least one of an alkali metal hydroxide or alkaline earth metal hydroxide, and the oxidant constituent includes at least one of an alkali metal-halogen or alkaline earth metal-halogen compound.

54. The electrochemical device of claim 41, wherein the electrolyte includes a proton exchange membrane or polymer electrolyte membrane (PEM), a perovskite material, or an electrolytic fluid.
